(19) United States
(12) Patent Application Publication
(10) Pub. No.: US 2025/0277085 A1
(43) Pub. Date: Sep. 4, 2025

(54) RESIN COMPOSITION, DRY FILM, AND CURED PRODUCT

(71) Applicant: TAIYO HOLDINGS CO., LTD., Hiki-gun (JP)

(72) Inventors: Kasumi HASHIMOTO, Hiki-gun (JP); Mami NOSAKA, Hiki-gun (JP); Yoshitomo AOYAMA, Hiki-gun (JP); Takumi SUZUKI, Hiki-gun (JP); Kota OKI, Hiki-gun (JP); Yumi KONDO, Hiki-gun (JP); Daichi OKAMOTO, Hiki-gun (JP)

(21) Appl. No.: 19/066,941

(22) Filed: Feb. 28, 2025

(30) Foreign Application Priority Data
Feb. 29, 2024 (JP) 2024-029660

(51) Int. Cl. C08G 65/38

(52) U.S. Cl. CPC C08G 65/38

(57) ABSTRACT

The resin composition contains (A) a resin and (B) a radical polymerization initiator, the resin (A) has a radically polymerizable functional group, and when a glass transition temperature (Tg) of the resin (A) is X° C. and a temperature of an exothermic peak top when the radical polymerization initiator (B) is heated from a temperature of 25° C. to 300° C. at 5° C./min by differential scanning calorimetry (DSC) is Y° C., (X−18)≤Y≤250 is satisfied.

### CROSS-REFERENCE TO RELATED APPLICATIONS

This application claims priority based on Japanese Patent Application No. 2024-29660, filed on Feb. 29, 2024, with the Japan Patent Office, the entire disclosure of which is fully incorporated herein by reference.

### BACKGROUND

### Technical Field

The present invention relates to a resin composition, a dry film, and a cured product.

### Related Art

In recent years, with the spread of large-capacity high-speed communication represented by the fifth generation communication system (5G), millimeter wave radars for an advanced driver assistance system (ADAS) of automobiles, and the like, the frequencies of signals for electronic devices have been increased.

For a printed wiring board built in such an electronic device, a curable resin composition containing an epoxy resin or the like as a main component has been used as an interlayer insulating material. A cured product including such a composition has a high relative permittivity (Dk) and a high dielectric loss tangent (Df), and has increased transmission loss with respect to signals in a high frequency band, causing problems such as signal attenuation and heat generation. Therefore, polyphenylene ethers excellent in low dielectric properties have attracted attention.

J. Nunoshige, H. Akahoshi, Y. Shibasaki, M. Ueda, J. Polym. Sci. Part A: Polym. Chem. 2008, 46, 5278-5282 proposes a polyphenylene ether in which heat resistance is improved by introducing an allyl group into a molecule of the polyphenylene ether to form a thermosetting resin.

### PRIOR ART DOCUMENTS

### Non-Patent Literature

[Non-Patent Literature 1] J. Nunoshige, H. Akahoshi, Y. Shibasaki, M. Ueda, J. Polym. Sci. Part A: Polym. Chem. 2008, 46, 5278-5282.

### SUMMARY

When a resin composition using such a polyphenylene ether is cured by a radical reaction and used as an interlayer insulating material or the like, the resin composition is generally cured in an inert gas atmosphere such as nitrogen so that the curing reaction is not inhibited by oxygen.

On the other hand, from the viewpoint of equipment and safety, it is required to obtain a cured product by curing in an air atmosphere instead of an inert gas such as nitrogen. However, when a resin composition using polyphenylene ether is cured in an air atmosphere, a curing reaction hardly proceeds, and plating swelling (swelling) occurs between a substrate and an insulating (cured product) layer. The plating swelling refers to a phenomenon in which a part of the insulating layer is released from the substrate in the plating step. For this reason, when curing is performed in an air atmosphere, it has been difficult to obtain a cured product having quality equivalent to that when curing is performed in an inert gas atmosphere.

Therefore, an object of the present invention is to provide a resin composition capable of suppressing swelling of an insulating layer even when cured in an air atmosphere; a dry film including a resin layer formed of the resin composition; and a cured product obtained using the resin composition or the resin layer of the dry film.

One aspect of the present invention is a resin composition. The resin composition contains (A) a resin and (B) a radical polymerization initiator, the resin (A) has a radically polymerizable functional group, and when a glass transition temperature (Tg) of the resin (A) is X° C. and a temperature of an exothermic peak top when the radical polymerization initiator (B) is heated from a temperature of 25° C. to 300° C. at 5° C./min by differential scanning calorimetry (DSC) is Y° C., (X−18)≤Y≤250 is satisfied.

In the resin composition of the above aspect, the resin composition preferably contains (C) a low molecular weight component having a radically polymerizable functional group and having a molecular weight of 1,000 or less.

In the resin composition of the above aspect, the radically polymerizable functional group of the resin (A) is preferably one or more selected from the group consisting of a vinyl group, an allyl group, and a maleimide group.

In the resin composition of the above aspect, the radical polymerization initiator (B) preferably has a peroxide structure (however, a structure represented by —O—O—H is excluded.) or an oxime ester structure.

In the resin composition of the above aspect, the resin (A) is preferably a branched polyphenylene ether resin.

In the resin composition of the above aspect, the resin (A) preferably has a weight average molecular weight Mw of 2,000 or more.

Another aspect of the present invention is a dry film. The dry film includes a resin layer formed of the resin composition of the above aspect.

Another aspect of the present invention is a cured product. The cured product is obtained using the resin composition of the above aspect or the resin layer of the dry film of the above aspect.

In the cured product of the above aspect, the cured product is preferably obtained by curing the resin composition or the resin layer in an air atmosphere.

According to the present invention, a resin composition capable of suppressing swelling of an insulating layer even when cured in an air atmosphere; a dry film including a resin layer formed of the resin composition; and a cured product obtained using the resin composition or the resin layer of the dry film can be provided.

### DETAILED DESCRIPTION

Hereinafter, embodiments of the present invention will be described in detail. The expression “a to b” used herein for the description of the numerical range means a or more and b or less unless otherwise specified.

When isomers are present in the compounds described, all isomers that may be present are usable in the present invention unless otherwise indicated.

In the present specification, phenols that can be used as raw materials of polyphenylene ether (PPE) and can serve as constitutional units of the polyphenylene ether are collectively referred to as “raw material phenols”.

In the present specification, when raw material phenols are expressed as “ortho position”, “para position”, or the like, unless otherwise specified, the position of the phenolic hydroxyl group is used as a reference (ipso position).

In the present specification, when simply expressed as “ortho position” or the like, “at least one of ortho positions” or the like is indicated. Therefore, as long as there is no particular contradiction, the term “ortho position” may be interpreted as indicating either one of the ortho positions or may be interpreted as indicating both of the ortho positions.

In the present specification, a polyphenylene ether in which some or all functional groups (for example, a hydroxyl group) of the polyphenylene ether are modified may be simply referred to as a “polyphenylene ether”. Therefore, the phrase “polyphenylene ether” includes both an unmodified polyphenylene ether and a modified polyphenylene ether unless there is a particular contradiction.

In the present specification, monovalent phenols are mainly disclosed as the raw material phenols, but polyvalent phenols may be used as the raw material phenols as long as the effect of the present invention is not inhibited.

In the present specification, when the upper limit value and the lower limit value of the numerical range are described separately, all combinations of each lower limit value and each upper limit value are substantially described within a range that does not contradict each other.

In the present specification, the solid content is used to mean a nonvolatile content (a component other than a volatile component such as a solvent).

In the present specification, the “resin” refers to a compound having a molecular weight distribution and having a molecular weight distribution (Mw/Mn) of more than 1. Mw represents a weight average molecular weight, and Mn represents a number average molecular weight. In addition, the “low molecular weight component” refers to a compound composed of a single molecule having no molecular weight distribution.

In the present specification, the components contained in the resin composition and the components contained in the resin layer that is a dry coating film of the resin composition may be described without distinction.

### 1. Resin Composition

The resin composition of the present embodiment contains (A) a resin, (B) a radical polymerization initiator, and (C) a low molecular weight component. In addition, the resin composition may contain other components as long as the effect of the present invention is not impaired.

When a glass transition temperature (Tg) of the resin (A) described later is X° C. and an exothermic peak top temperature when the radical polymerization initiator (B) described later is heated from a temperature of 25° C. to 300° C. at 5° C./min by differential scanning calorimetry (DSC) is Y° C., the resin composition of the present embodiment satisfies (X−18)≤Y≤250. Hereinafter, each component contained in the resin composition will be described in detail.

### 1-1. (A) Resin

The resin (A) is not particularly limited as long as it is a resin (polymer) having a radically polymerizable functional group and in which a polymerization reaction proceeds by a radical polymerization initiator.

The radically polymerizable functional group is preferably, for example, an ethylenically unsaturated group having a carbon-carbon double bond. The ethylenically unsaturated group is preferably one or more selected from the group consisting of an acrylic group, a methacrylic group, a styryl group, olefin groups (a vinyl group, an allyl group, a propenyl group, and the like), and a maleimide group. Of the ethylenically unsaturated groups described above, the radically polymerizable functional group is more preferably one or more selected from the group consisting of a vinyl group, an allyl group, and a maleimide group from the viewpoint of dielectric properties. The resin (A) may have one or more radically polymerizable functional groups.

The number of radically polymerizable functional groups in the molecule of the resin (A) is not particularly limited, and may be one or more, and is preferably two or more from the viewpoint of mechanical physical properties.

The resin (A) is not particularly limited, and for example, a polyester resin such as polyethylene terephthalate (PET) or polyethylene naphthalate (PEN); a polyamide resin; a polyamideimide resin; a polyphenylene sulfide resin; a polyether ether ketone resin; a polyethersulfone resin; a polycarbonate resin; a polyetherimide resin; an epoxy resin; a phenol resin; a phenoxy resin; a glass-epoxy resin; a polyphenylene ether resin (PPE); an acrylic resin; a silicone resin; a polyolefin resin such as polyethylene or polypropylene; a polycycloolefin resin such as polynorbornene, a triazine-based resin such as melamine, or the like can be used. These resins can be used singly or in combination of two or more.

From the viewpoint of setting the glass transition temperature (Tg) to a proper value, the resin (A) is preferably a polyphenylene ether resin. The main chain structure of the polyphenylene ether resin may be either a linear structure or a branched structure.

The polyphenylene ether resin having a branched structure (also referred to as branched polyphenylene ether resin or branched PPE) is excellent in solubility in a solvent, compatibility and reactivity with each component in the resin composition. Therefore, the resin (A) is preferably a branched polyphenylene ether resin.

The branched polyphenylene ether resin is a polyphenylene ether produced from raw material phenols including phenols having a hydrogen atom at an ortho position and a para position. Such phenols have a hydrogen atom at the ortho position, and thus an ether bond can be formed not only at the ipso position and the para position but also at the ortho position when oxidatively polymerized with the phenols, so that the polyphenylene ether obtained using such phenols as raw material phenols can form a branched chain structure.

The glass transition temperature (Tg) of the resin (A) is preferably 100° C. or higher, 150° C. or higher, 180° C. or higher, or the like, and is preferably 230° C. or lower, 220° C. or lower, 200° C. or lower, or the like. The glass transition temperature (Tg) can be measured by differential scanning calorimetry (DSC). When the glass transition temperature of the resin (A) is within the above range, a cured product excellent in mechanical properties, heat resistance, and the like can be obtained.

The resin (A) has a weight average molecular weight (Mw) of preferably 1,000 or more, 1,500 or more, 2,000 or more, or the like, and preferably 150,000 or less, 100,000 or less, 80,000 or less, or the like. The weight average molecular weight (Mw) can be determined from a value in terms of standard polystyrene by gel permeation chromatography (GPC). The GPC can be measured using a high-speed GPC apparatus (HLC-8320GPC, manufactured by Tosoh Corporation) as a measuring apparatus, chloroform as an eluent, and an RI detector as a detector.

The resin (A) may be a mixture of two or more polyphenylene ethers having different kinds of raw material phenols.

The amount of the resin (A) added is, for example, preferably 0.1% by mass or more, 0.5% by mass or more, 1% by mass or more, 3% by mass or more, 5% by mass or more, or the like, and preferably 40% by mass or less, 35% by mass or less, 30% by mass or less, 25% by mass or less, or the like, based on the total solid content of the resin composition.

### 1-2. (B) Radical Polymerization Initiator

The radical polymerization initiator (B) is a compound having an action of generating radicals by heat or light irradiation such as ultraviolet rays. As such a radical polymerization initiator (B), any of a thermal polymerization initiator that generates radicals by heat (thermal radical initiator), a photopolymerization initiator that generates radicals by light irradiation (photoradical initiator), or a photothermal dual initiator that generates radicals by both light and heat may be used depending on the application of the resin composition.

Hereinafter, the radical polymerization initiator will be described in detail. The thermal polymerization initiator and the photothermal dual initiator, and the photopolymerization initiator and the photothermal dual initiator may be redundantly exemplified.

### Thermal Polymerization Initiator

The thermal polymerization initiator is preferably a peroxide containing a peroxide structure (—O—O—). Examples of the peroxide include methyl ethyl ketone peroxide, methyl acetoacetate peroxide, acetylacetoperoxide, 1,1-bis(t-butylperoxy)cyclohexane, 2,2-bis(t-butylperoxy) butane, t-butyl hydroperoxide, cumene hydroperoxide, diisopropylbenzene hydroperoxide, 2,5-dimethylhexane-2,5-dihydroperoxide, 1,1,3,3-tetramethylbutyl hydroperoxide, di-t-butyl hydroperoxide, t-butyl hydroperoxide, dicumyl peroxide, 2,5-dimethyl-2,5-di(t-butylperoxy)hexane, 2,5-dimethyl-2,5-di(t-butylperoxy) hexyne, 2,5-dimethyl-2,5-di(t-butylperoxy)-3-butene, acetyl peroxide, octanoyl peroxide, lauroyl peroxide, benzoyl peroxide, m-toluyl peroxide, diisopropylperoxydicarbonate, t-butylene peroxybenzoate, di-t-butyl peroxide, t-butylperoxyisopropyl monocarbonate, and α,α′-bis(t-butylperoxy-m-isopropyl)benzene.

Of these, the peroxide having a 1-minute half-life temperature of 130° C. to 180° C. is desirable from the viewpoint of ease of handling and reactivity. Since such a peroxide has a relatively high reaction starting temperature, it is difficult to accelerate curing at the time when curing is not required, such as during drying, and the preservability of the resin composition is not deteriorated, and the peroxide has low volatility, and thus does not volatilize during drying or during storage, and has good stability.

Also, as the thermal polymerization initiator, azo compounds such as 2,2′-azobisisobutyronitrile, 2,2′-azobis(2,4-dimethylvaleronitrile), and 2,2′-azobis(4-methoxy-2′-dimethylvaleronitrile) may be used.

These can be used singly or in combination of two or more.

### Photopolymerization Initiator

Examples of the photopolymerization initiator include those containing an oxime ester structure, an α-aminoacetophenone structure, a hydroxyacetophenone structure, an acylphosphine oxide structure, a benzoin structure, a benzophenone structure, an acetophenone structure, a thioxanthone structure, an anthraquinone structure, a ketal structure, a benzoic acid ester structure, a titanocene structure, or the like. Of these, those having an oxime ester structure are preferable.

Examples of those having an oxime ester structure include 2-(benzoyloxyimino)-1-[4-(phenylthio)phenyl]octan-1-one (OXE01), [1-[9-ethyl-6-(2-methylbenzoyl)carbazol-3-yl]ethylideneamino]acetate, ethanone-1-[9-ethyl-6-(2-methylbenzoyl)-9H-carbazol-3-yl]-1-(O-acetyloxime) (OXE02), and the like.

These can be used singly or in combination of two or more.

### Photothermal Dual Initiator

The photothermal dual initiator is preferably a peroxide containing a peroxide structure (—O—O—), and examples thereof include 3,3,4,4-tetra(t-butylperoxycarbonyl) benzophenone, 2-(1-t-butylperoxy-1-methylethyl)-9H-thioxanthen-9-one, and the like.

Among the above, the radical polymerization initiator (B) preferably has a peroxide structure (however, a structure represented by —O—O—H is excluded.) or an oxime ester structure. Furthermore, among the above, the radical polymerization initiator (B) is preferably a compound having higher solvent solubility, and for example, a compound having a structure containing a hetero atom is more preferable.

More specifically, 2-(1-t-butylperoxy-1-methylethyl)-9H-thioxanthen-9-one, Irgacure OXE02 (manufactured by BASF Japan Ltd.) as a commercially available product, and the like are more preferable, and 2-(1-t-butylperoxy-1-methylethyl)-9H-thioxanthen-9-one is particularly preferable. By using 2-(1-t-butylperoxy-1-methylethyl)-9H-thioxanthen-9-one as the radical polymerization initiator (B), the stability of the resin composition can be secured even under white light.

Assuming that a temperature of an exothermic peak top when the radical polymerization initiator (B) is heated from a temperature of 25° C. to 300° C. at 5° C./min by differential scanning calorimetry (DSC) is Y° C., Y satisfies (X−18)≤Y≤250 when a glass transition temperature (Tg) of the resin (A) described above is X° C. That is, Y is preferably 82° C. or higher, 132° C. or higher, 162° C. or higher, or the like, and can be set to a value of 250° C. or lower.

When Y is within the above range, the stability of the radical polymerization initiator (B) can be maintained to a value relatively close to the glass transition temperature (Tg) X of the resin (A), so that the crosslinking density when the resin composition is cured is improved, and the breaking strength can be improved. In addition, even when the resin composition is cured in an air atmosphere, plating swelling can be suppressed.

The amount of the radical polymerization initiator (B) added can be 0.01 to 15 parts by mass relative to 100 parts by mass of the solid content of the resin (A).

### 1-3. (C) Low Molecular Weight Component

The low molecular weight component (C) of the present embodiment has a radically polymerizable functional group and has a molecular weight of 1,000 or less. Since the radically polymerizable functional group is the same as the radically polymerizable functional group described in “1-1. (A) Resin”, the description thereof is omitted here.

As the low molecular weight component (C), it is preferable to use a compound that undergoes a curing reaction with the resin (A) and has good compatibility with the resin (A). Examples of the low molecular weight component (C) include polyfunctional vinyl compounds such as divinylbenzene, divinylnaphthalene, and divinylbiphenyl; vinyl benzyl ether-based compounds synthesized from reaction of phenol and vinyl benzyl chloride; allyl ether-based compounds synthesized from reaction of styrene monomer, phenol, and allyl chloride; (meth) acrylate compounds (methacrylate compound and acrylate compound); trialkenyl isocyanurate; and the like.

Among them, trialkenyl isocyanurate is preferable from the viewpoint of having particularly good compatibility with the resin (A) and improving low dielectric properties and heat resistance of the cured product, and specifically, triallyl isocyanurate {hereinafter, TAIC (registered trademark)} and triallyl cyanurate (hereinafter, TAC) are preferable. The low molecular weight component (C) can be used singly or in combination of two or more.

The molecular weight of the low molecular weight component (C) is preferably 1,000 or less, more preferably 500 or less, and still more preferably 400 or less from the viewpoint of crosslinking density. The number of functional groups in the low molecular weight component (C) is preferably 2 to 4 from the viewpoint of the mechanical physical properties of the resulting cured product. The low molecular weight component (C) has a melting point of preferably 80° C. or lower from the viewpoint of melt viscosity. By containing the low molecular weight component (C) described above, when preparing the dry film described later from the resin composition, warpage of the dry film can be reduced. In addition, even when the resin composition is cured in an air atmosphere, plating swelling can be suppressed.

The amount of the low molecular weight component (C) added can be 10 to 200 parts by mass, 50 to 150 parts by mass, or the like relative to 100 parts by mass of the solid content of the resin (A).

### 1-4. Other Components

As other components, known components such as fillers (organic fillers such as PTFE powder in addition to inorganic fillers), flame retardant improvers (phosphorus compounds and the like), cellulose nanofibers, cyanate ester resins, epoxy resins, phenol novolac resins, elastomers, dispersants, curing accelerators, crosslinkable curing agents (crosslinking agents), adhesion imparting agents, and solvents may be contained.

### Inorganic Filler

As the inorganic filler, a metal oxide such as alumina or titanium oxide; a metal hydroxide such as aluminum hydroxide or magnesium hydroxide; a clay mineral such as talc or mica; a filler having a perovskite-type crystal structure such as barium titanate or strontium titanate; silica, boron nitride, aluminum borate, barium sulfate, calcium carbonate, or the like can be used.

Of the above-described inorganic fillers, silica improves the film formability of the resin composition, and can realize a low dielectric loss tangent and a low thermal expansion at a high level.

The silica has an average particle size of preferably 0.02 to 10 μm, and more preferably 0.02 to 3 μm. Here, the average particle size can be determined as a median diameter (d50, based on volume) by a cumulative distribution from a measured value of a particle size distribution by a laser diffraction/scattering method using a commercially available laser diffraction/scattering type particle size distribution measuring apparatus. In addition, the average particle size of silica refers to a value obtained by measuring a powdery material before preparing (pre-stirring and kneading) the resin composition as described above.

Silicas having different average particle sizes can also be used in combination. From the viewpoint of highly filling the silica, for example, minute silica of nano-order having an average particle size of less than 1 μm may be used in combination with silica having an average particle size of 1 μm or more.

The silica may be surface-treated with a coupling agent. By treating the surface with a silane coupling agent, dispersibility with the polyphenylene ether can be improved. In addition, the affinity with an organic solvent can also be improved.

As the silane coupling agent, for example, an epoxysilane coupling agent, a mercaptosilane coupling agent, a vinylsilane coupling agent, or the like can be used. As the epoxysilane coupling agent, for example, γ-glycidoxypropyltrimethoxysilane, γ-glycidoxypropylmethyldimethoxysilane, or the like can be used. As the mercaptosilane coupling agent, for example, γ-mercaptopropyltriethoxysilane or the like can be used. As the vinylsilane coupling agent, for example, vinyltriethoxysilane or the like can be used.

The amount of the silane coupling agent used may be, for example, 0.1 to 5 parts by mass or 0.5 to 3 parts by mass relative to 100 parts by mass of silica.

The amount of the filler such as silica added may be 50 to 400 parts by mass or 100 to 400 parts by mass relative to 100 parts by mass of the solid content of the resin (A). Alternatively, the amount of the filler such as silica added may be 30 to 80% by mass based on the total solid content of the resin composition. By setting the amount of the filler added within the above-mentioned range, when preparing the dry film described later from the resin composition, warpage of the dry film can be reduced. In addition, even when the resin composition is cured in an air atmosphere, plating swelling can be suppressed.

### Elastomer

By containing an elastomer, the toughness of the dry film and cured product described later can be improved. Examples of the elastomer include diene-based synthetic rubbers such as polyisoprene rubber, polybutadiene rubber, styrene-butadiene rubber, polychloroprene rubber, nitrile rubber, and ethylene-propylene rubber, non-diene-based synthetic rubbers such as ethylene-propylene rubber, butyl rubber, acrylic rubber, polyurethane rubber, fluororubber, silicone rubber, and epichlorohydrin rubber, natural rubber, styrene-based elastomers, olefin-based elastomers, urethane-based elastomers, polyester-based elastomers, polyamide-based elastomers, acrylic elastomers, silicone-based elastomer, and the like.

From the viewpoint of compatibility with the resin (A) and dielectric properties, at least a part of the elastomer is preferably a styrene-based elastomer. Examples of the styrene-based elastomer include: styrene-butadiene copolymers such as styrene-butadiene-styrene block copolymers and styrene-butadiene-butylene-styrene block copolymers; styrene-isoprene copolymers such as styrene-isoprene-styrene block copolymers; styrene-ethylene-butylene-styrene block copolymers; styrene-ethylene-propylene-styrene block copolymers; and the like. A styrene-based elastomer having no unsaturated carbon bond, such as a styrene-ethylene-butylene-styrene block copolymer, is preferable because the obtained cured product has particularly good dielectric properties.

The content ratio of the styrene block in the styrene-based elastomer is preferably 10 to 70% by mass, 30 to 60% by mass, or 40 to 50% by mass. The content ratio of the styrene block can be determined from the integral ratio of the spectrum measured by ¹H-NMR.

Here, the raw material monomers of the styrene-based elastomer include not only styrene but also styrene derivatives such as α-methylstyrene, 3-methylstyrene, 4-propylstyrene, and 4-cyclohexylstyrene.

The content ratio of the styrene-based elastomer in 100% by mass of the elastomer may be, for example, 10% by mass or more, 20% by mass or more, 30% by mass or more, 40% by mass or more, 50% by mass or more, 60% by mass or more, 70% by mass or more, 80% by mass or more, 90% by mass or more, 95% by mass or more, or 100% by mass.

The elastomer may be modified using (meth) acrylic acid, maleic acid, an anhydride or an ester thereof. In addition, the elastomer may be obtained by further adding water to the residual unsaturated bond of the diene-based elastomer.

The elastomer may have a number average molecular weight of 1,000 to 150,000. When the number average molecular weight is the lower limit value or more, excellent low thermal expansion is obtained, and when the number average molecular weight is the upper limit value or less, excellent compatibility with other components is obtained.

The amount of the elastomer added may be 10 to 300 parts by mass relative to 100 parts by mass of the solid content of the resin (A) in the resin composition. Alternatively, the amount of the elastomer added may be 3 to 65% by mass based on the total solid content in the resin composition. Within the above range, good tensile properties, adhesion, and heat resistance can be achieved in a well-balanced manner.

### Solvent

The resin composition of the present invention is usually provided or used in a state in which the resin (A) is dissolved in a solvent.

Examples of the solvent that can be used in the resin composition of the present embodiment include solvents with relatively high safety, such as N-methyl-2-pyrrolidone (NMP), tetrahydrofuran (THF), cyclohexanone, propylene glycol monomethyl ether acetate (PMA), diethylene glycol monoethyl ether acetate (CA), methyl ethyl ketone, and ethyl acetate, in addition to conventionally usable solvents such as chloroform, methylene chloride, and toluene. The solvent may be N,N-dimethylformamide (DMF). The solvent may be used alone or in combination of two or more.

The amount of the solvent added in the resin composition of the present embodiment is not particularly limited, and can be appropriately adjusted according to the application of the resin composition.

### 2. Dry Film

The dry film of the present embodiment can be produced by applying the resin composition of the present embodiment to a first film (for example, a carrier film) and drying it to form a resin layer as a dry coating film. A second film (for example, a protective film) can be laminated on the resin layer as necessary. That is, the dry film includes a resin layer formed of a resin composition.

The first film plays a role of supporting the resin layer of the dry film, and refers to a film that is bonded to at least the resin layer when the first film is laminated on a base material such as a substrate by heating or the like so that the resin layer side of the dry film is in contact with the base material, and integrally molded. As the first film, for example, a polyester film such as polyethylene terephthalate or polyethylene naphthalate, a film made of a thermoplastic resin such as a polyimide film, a polyamideimide film, a polyethylene film, a polytetrafluoroethylene film, a polypropylene film, or a polystyrene film, surface-treated paper, or the like can be used. Of these, a polyester film can be suitably used from the viewpoint of heat resistance, mechanical strength, handleability, and the like. The thickness of the first film is not particularly limited, and is appropriately selected in a range of about 10 to 150 μm according to the application. The surface of the first film on which the resin layer is provided may be subjected to release treatment. In addition, sputtering or a copper foil may be formed on the surface of the first film on which the resin layer is provided.

The second film is provided on a surface of the resin layer opposite to the first film for the purpose of preventing adhesion of dust or the like to the surface of the resin layer of the dry film and improving handleability. The second film is peeled off from the resin layer before lamination when the second film is laminated on the base material by heating or the like so that the resin layer side of the dry film is in contact with the base material such as a substrate, and integrally molded. As the second film, for example, a film made of the thermoplastic resin exemplified in the first film, surface-treated paper, and the like can be used, and of these, a polyester film, a polyethylene film, and a polypropylene film are preferable. The thickness of the second film is not particularly limited, and is appropriately selected in a range of about 10 to 150 um according to the application. The surface of the second film on which the resin layer is provided may be subjected to release treatment. In addition, when the second film is peeled off, the adhesive force between the resin layer and the second film is preferably smaller than the adhesive force between the resin layer and the first film.

As a film to which the resin composition of the present invention is applied in the production of a dry film, either the first film or the second film may be used.

### 3. Cured Product

The cured product of the present embodiment is obtained by curing the resin composition of the present embodiment or the resin layer of the dry film of the present embodiment.

The curing method is not particularly limited, and curing may be performed by a conventionally known method, for example, curing may be performed by heating at 150 to 230° C. The method for obtaining a cured product from the resin composition is not particularly limited, and can be appropriately changed according to the composition of the resin composition. As an example, after a step of applying (for example, application by an applicator or the like) the resin composition on a substrate on which a circuit pattern is formed is performed, a drying step of drying the resin composition is performed as necessary, and a thermal curing step of thermally crosslinking the polyphenylene ether by heating (for example, heating by an inert gas oven, a hot plate, a vacuum oven, a vacuum press machine, or the like) may be performed. The implementation conditions (for example, coating thickness, drying temperature and time, heating temperature and time, and the like) in each step may be appropriately changed according to the composition, application, and the like of the resin composition.

In addition, when a cured product is obtained using a dry film with a three-layer structure in which a resin layer is sandwiched between a first film and a second film, a printed wiring board can be produced by the following method. A thermal curing step of peeling off the second film from the dry film, heating and laminating the resin layer on the substrate on which the circuit pattern is formed, and then thermally curing the resin layer is performed. The thermal curing step may be cured in an oven or by a hot plate press. When the substrate on which the circuit is formed and the dry film of the present invention are laminated or hot-plate pressed, a copper foil or the base material on which the circuit is formed can be laminated simultaneously. A printed wiring board can be produced by forming a pattern or a via hole by laser irradiation or a drill at a position corresponding to a predetermined position on the substrate on which the circuit pattern is formed to expose the circuit wiring. At this time, in a case where there is a component that has not been removed and remains on the circuit wiring in the pattern or the via hole (smear), a desmear treatment is performed. The first film may be peeled off after lamination, after thermal curing, after laser processing, or after desmear treatment.

The thermal curing step described above may be performed in an inert gas atmosphere such as nitrogen or an air atmosphere. That is, the cured product of the present embodiment can be obtained by curing the resin composition or the resin layer of the present embodiment in an air atmosphere other than an inert gas atmosphere such as nitrogen.

The glass transition temperature (Tg) of the obtained cured product is preferably 150° C. or higher, 160° C. or higher, 170° C. or higher, or the like. When the glass transition temperature of the cured product is in the above range, the cured product is excellent in mechanical properties, heat resistance, and the like.

### EXAMPLES

Next, the present invention will be described in detail with reference to Examples and Comparative Examples, but the present invention is not limited thereto at all.

### Synthesis of Resin (A) (Branched PPE)

To a 500 mL separable flask, 19.8 g (0.16 mol) of 2,6-dimethylphenol and 2.42 g (0.018 mol) of 2-allylphenol were added, and the resulting mixture was dissolved in 261 g of toluene. Furthermore, di-μ-hydroxo-bis[(N,N,N′,N′-tetramethylethylenediamine)copper(II)]chloride (Cu/TMEDA) and tetramethylethylenediamine (TMEDA) were adjusted to be 0.18 wt % and 0.16 wt %, respectively, and the mixture was stirred at a stirring speed of 200 rpm using a four-blade paddle impeller and reacted at 40° C. for a predetermined time while blowing dry air into the reaction liquid at a flow rate of 75 mL/min to obtain a reaction liquid containing polyphenylene ether. After stopping the heating of the reaction liquid and blowing of dry air, di-μ-hydroxo-bis[(N,N,N′,N′-tetramethylethylenediamine)copper(II)]chloride (Cu/TMEDA) was removed by filtration, reprecipitated with a mixed liquid of 1,200 mL of methanol, 4.0 mL of concentrated hydrochloric acid and 27.0 mL of H₂O, taken out by reduced pressure filtration, washed with methanol, and then dried at 80° C. for 24 hours to obtain a reactive branched polyphenylene ether. The obtained reactive branched polyphenylene ether (branched PPE) had a number average molecular weight (Mn) of 14,000 and a weight average molecular weight of 38,000 (Mw).

### Measurement of Glass Transition Temperature (Tg)×of Resin (A) (Branched PPE)

The glass transition point (Tg) of the resin (A) (branched PPE) was measured under the following conditions using a differential scanning calorimetry (DSC) (Q100 manufactured by TA Instruments Japan Inc., heat flux type).

As temperature conditions, the temperature was raised from 25° C. to 300° C. at a temperature raising rate of 5° C./min (1st Run), rapidly cooled from 300° C. to −50° C. at 10° C./min using liquid nitrogen, and raised again from −50° C. to 300° C. at a temperature raising rate of 5° C./min (2nd Run). The inflow gas was nitrogen, and the flow rate of the nitrogen gas was 50 ml/min. The amount of the sample for measurement was 5 mg, and an aluminum container for measurement was used as the sample container.

The glass transition point (Tg) was measured from the DSC curve of the 2nd Run. The glass transition point (Tg) was defined as the temperature of the point at which the straight line at an equal distance in the vertical axis direction from the straight line extending from each baseline intersects with the curve of the portion showing the stepwise change in glass transition (intermediate glass transition temperature). The value of the glass transition point (Tg) of the resin (A) (branched PPE) is indicated in Table 1 below as X.

### Measurement of Exothermic Peak Top Temperature Y of Radical Polymerization Initiator (B)

The top temperature of the exothermic peak of the compound indicated in Table 1 below used as the radical polymerization initiator (B) was measured under the following conditions using a differential scanning calorimetry (DSC) apparatus (Q100 manufactured by TA Instruments Japan Inc., heat flux type).

The temperature was raised from a temperature of 25° C. to 300° C. at a temperature raising rate of 5° C./min. The inflow gas was nitrogen, and the flow rate of the nitrogen gas was 50 ml/min. The amount of the sample for measurement was 5 mg, and an aluminum container for measurement was used as the sample container.

In the obtained DSC curve, the value of the exothermic peak top temperature of the radical polymerization initiator (B) is indicated in Table 1 below as Y.

### Relationship Between X and Y

Whether or not X and Y described above satisfy the following equations was calculated.

(X−18)≤Y≤250

### (Evaluation Criteria)

A: X and Y satisfy the above equation.
C: X and Y do not satisfy the above equation.

### Preparation of Resin Composition

### Example 1

1.60 g (100 parts by mass) of the branched PPE and 1.20 g (75 parts by mass) of an elastomer (manufactured by Asahi Kasei Corporation: trade name “TUFTEC H1051”) were completely dissolved by adding 9.7 g of anisole as a solvent and thoroughly stirring the mixture with a planetary centrifugal mixer. To the branched PPE resin solution thus obtained, 1.20 g (75 parts by mass) of tricyclodecane dimethanol diacrylate (manufactured by SHIN-NAKAMURA CHEMICAL Co., Ltd.: trade name “A-DCP”) as a low molecular weight component and 3.97 g (248 parts by mass) of a spherical silica filler (manufactured by Admatechs Company Limited, trade name: “SC2050-HNF”, solid content concentration: 70%) were each added, and the mixture was stirred with a planetary centrifugal mixer. Finally, 0.16 g (10 parts by mass) of ethanone-1-[9-ethyl-6-(2-methylbenzoyl)-9H-carbazol-3-yl]-1-(O-acetyloxime) (manufactured by BASF Japan Ltd.: trade name “Irgacure OXE02”) as a radical polymerization initiator was added thereto, and the mixture was thoroughly stirred with a planetary centrifugal mixer to obtain a varnish of a resin composition of Example 1.

### Examples 2 to 3, Comparative Examples 1 to 2

The same procedure as in Example 1 was carried out except that the components and the contents were changed to the values shown in Table 1 below to obtain varnishes of resin compositions according to Examples 2 to 3 and Comparative Examples 1 to 2.

### Preparation of Test Sample Substrate

### (Preparation Step of CZ-Treated Substrate)

Both surfaces of a substrate (copper-clad laminate, manufactured by MITSUBISHI GAS CHEMICAL COMPANY, INC., CCL-HL832NX, TYPE A Series, thickness 0.4 mm) were subjected to a roughening treatment using a roughening agent (manufactured by MEC COMPANY LTD.: trade name “CZ8100”) under such conditions that the etching amount was about 1 μm, thereby preparing a CZ-treated substrate.

### (Step of Preparing Dry Film)

The varnish of the resin composition of each of Examples and Comparative Examples was applied onto a 38 μm-thick extremely smooth grade PET film (manufactured by Toray Industries, Inc.: trade name “R80”) as a first film using an applicator so that the thickness after drying was a value shown in 35 μm, and then dried in a hot air circulation drying furnace at 90° C. for 15 minutes to obtain a test dry film of each of Examples and Comparative Examples.

### (Lamination/Curing Step)

The test dry film of each of Examples and Comparative Examples was disposed so that the resin layer of the dry film was in contact with both surfaces of the CZ-treated substrate obtained by the above-described procedure. After lamination at 140° C. and 0.8 MPa using a vacuum laminator (“CVP-600” manufactured by Nikko-Materials Co., Ltd.), the laminate was cured by heating for 60 minutes in an air atmosphere at 200° C. using a hot air circulation drying furnace to prepare a test substrate including a cured product of each resin layer.

### (Desmear Step)

The surface of each test substrate was subjected to a desmear treatment using a commercially available desmear treatment liquid. Specifically, the test substrate from which the PET film had been peeled off was immersed in a swelling liquid (manufactured by Atotech Japan K.K.,: trade name “Swelling Dip Securiganth P”) at 60° C. for 5 minutes, then immersed in a roughening liquid (manufactured by Atotech Japan K.K.,: trade name “Concentrate Compact CP”) at 80° C. for 20 minutes, and then immersed in a neutralizing liquid (manufactured by Atotech Japan K.K.,: trade name “Reduction Securiganth P500”) at 40° C. for 5 minutes.

### (Plating Layer Forming Step)

An electroless plating treatment and an electrolytic plating treatment were performed on the surface of each test substrate subjected to the desmear step to form a copper plating layer. Specifically, as the electroless plating treatment, electroless copper plating was performed by immersion in a cleaner treatment liquid (manufactured by C.Uyemura & Co., Ltd.: trade name “Cleaner MCD-PL”) at 40° C. for 5 minutes, immersion in a soft etching treatment liquid (manufactured by C.Uyemura & Co., Ltd.:

trade name “ALCUP MDP-2”) at 25° C. for 2 minutes, immersion in a catalyst-imparting treatment liquid (manufactured by C.Uyemura & Co., Ltd.: trade name “ALCUP MAT-SP”) at 40° C. for 5 minutes, immersion in a reducing treatment liquid (manufactured by C.Uyemura & Co., Ltd.: trade name “ALCUP MRD-2-C/MAB-4-C/MAB-4-A”) at 35° C. for 3 minutes, and immersion in a reaction promoting treatment liquid (manufactured by C.Uyemura & Co., Ltd.: trade name “ALCUP MEL-3-A”) at 25° C. for 1 minute, and immersion in an electroless plating treatment liquid (manufactured by C.Uyemura & Co., Ltd.: trade name “THRU-CUP PEA V2”) at 36° C. for 20 minutes. Thereafter, as the electrolytic plating treatment, electrolytic copper plating was performed under the conditions of a current density of 2 A/dm² by immersion in an acid washing solution (manufactured by Atotech Japan K.K.: trade name “acidic cleaner FR”) at 45° C. for 5 minutes, immersion in a 10% sulfuric acid aqueous solution at 25° C. for 1 minute, and immersion in an electrolytic copper plating solution at 23° C. for 60 minutes. Finally, as annealing treatment, heat treatment was performed at 190° C. for 60 minutes in a hot air circulation drying furnace. A test sample substrate was obtained by the above preparation method.

### Evaluation of Plating Swelling

The surface of the test sample substrate prepared by the resin composition of each of Examples and Comparative Examples after plating layer formation was visually confirmed to evaluate plating swelling. The ratio of the area where the plating layer was swollen on both sides of the substrate was calculated and evaluated according to the following evaluation criteria.

### (Evaluation Criteria)

A: Ratio of the area where swelling occurred of less than 5%
C: Ratio of the area where swelling occurred of 5% or more

### Evaluation of Stability Under White Light

The varnish of the resin composition of each of Examples and Comparative Examples was placed in a white poly container (“Hi-Resist” BHR-150″ manufactured by Kinki Yoki Co., Ltd.), and allowed to stand for 2 days under white light. Viscosity was measured using a cone-plate viscometer (TVE-33H, manufactured by Toki Sangyo Co., Ltd) before and after standing, and evaluated according to the following evaluation criteria.

### (Evaluation Criteria)

A: Viscosity increase rate of less than 30%
B: Viscosity increase rate of 30% or more and less than 100%
C: Viscosity increase rate of 100% or more

TABLE 1

| | | | | | | Comparative | |
|---|---|---|---|---|---|---|---|
| | | | Example | | | Example | |
| | | | 1 | 2 | 3 | 1 | 2 |
| Blended | (A) Resin | Branched PPE*¹ | 100 | 100 | 100 | 100 | 100 |
| components | (B) Radical | Irgacure OXE02*² | 10 | — | — | — | — |
| | polymerization | 2-(1-t-Butylperoxy- | — | 4 | 5 | — | — |
| | initiator | 1-methylethyl)-9H- | | | | | |
| | | thioxanthen-9-one*³ | | | | | |
| | | PERBUTYL P40*⁴ | — | — | — | 4 | 5 |
| | (C) Low molecular | A-DCP*⁵ | 75 | 75 | — | 75 | — |
| | weight component | TAIC*⁶ | — | — | 100 | — | 100 |
| | Elastomer | H1051*⁷ | 75 | 75 | 32 | 75 | 32 |
| | Filler | SC2050-HNF*⁸ | 248 | 248 | 224 | 248 | 224 |
| Relationship | X: Glass transition | (° C.) | 193 | 193 | 193 | 193 | 193 |
| between | temperature of (A) | | | | | | |
| X and Y | Y: Exothermic peak | (° C.) | 248 | 177 | 177 | 173 | 173 |
| | top temperature of (B) | | | | | | |

| | | | | | | |
|---|---|---|---|---|---|---|
| | (X − 18) ≤ Y ≤ 250 | A | A | A | C | C |
| Evaluation | Plating swelling in air atmosphere | A | A | A | C | C |
| results | Stability under white light | B | A | A | — | — |

*“—” indicates unevaluated.
Details of each component in Table 1 are shown below. The blending amount of each component is parts by mass, and is a value in terms of solid content.
<(A) Resin>
*¹Branched PPE described above
<(B) Radical polymerization initiator>
*²“Irgacure OXE02” {Ethanone-1-[9-ethyl-6-(2-methylbenzoyl)-9H-carbazol-3-yl]-1-(O-acetyloxime)} manufactured by BASF Japan Ltd.
*³“2-(1-t-Butylperoxy-1-methylethyl)-9H-thioxanthen-9-one” manufactured by NOF CORPORATION
*⁴“PERBUTYL P40” {α,α′-bis(t-butylperoxy-m-isopropyl)benzene} manufactured by NOF CORPORATION
<(C) Low molecular weight component>
*⁵“A-DCP” tricyclodecanedimethanol diacrylate, manufactured by SHIN-NAKAMURA CHEMICAL Co., Ltd.
*⁶“TAIC” triallyl isocyanurate manufactured by Mitsubishi Chemical Corporation
<Elastomer>
*⁷“TUFTEC H1051^{”} manufactured by Asahi Kasei Corporation
<Filler>
*⁸“SC2050-HNF” silica slurry manufactured by Admatechs Company Limited, solid content: 70% by mass, dispersion medium: cyclohexanone

The resin composition, the dry film, and the cured product of the present invention can suppress swelling of the insulating layer even when cured in an air atmosphere, and thus can be used as an interlayer insulating material or the like of a printed wiring board built in an electronic device.

What is claimed is:

1. A resin composition comprising: (A) a resin; and (B) a radical polymerization initiator, wherein
the resin (A) has a radically polymerizable functional group, and
when a glass transition temperature (Tg) of the resin (A) is X° C. and a temperature of an exothermic peak top when the radical polymerization initiator (B) is heated from a temperature of 25° C. to 300° C. at 5° C./min by differential scanning calorimetry (DSC) is Y° C., (X−18)≤Y≤250 is satisfied.

2. The resin composition according to claim 1, wherein the resin composition comprises (C) a low molecular weight component having a radically polymerizable functional group and having a molecular weight of 1,000 or less.

3. The resin composition according to claim 1, wherein the radically polymerizable functional group of the resin (A) is one or more selected from the group consisting of a vinyl group, an allyl group, and a maleimide group.

4. The resin composition according to claim 1, wherein the radical polymerization initiator (B) has a peroxide structure (however, a structure represented by —O—O—H is excluded.) or an oxime ester structure.

5. The resin composition according to claim 1, wherein the resin (A) is a branched polyphenylene ether resin.

6. The resin composition according to claim 1, wherein the resin (A) has a weight average molecular weight Mw of 2,000 or more.

7. A dry film comprising a resin layer formed of the resin composition according to claim 1.

8. A cured product obtained using the resin composition according to claim 1.

9. The cured product according to claim 8, wherein the cured product is obtained by curing the resin composition or the resin layer in an air atmosphere.

10. A cured product obtained using the resin layer of the dry film described in claim 7.
